(19) United States
(12) Patent Application Publication
(10) Pub. No.: US 2026/0213933 A1
(43) Pub. Date: Jul. 23, 2026

(54) Method and Device for Generating a Digital Access Key for a Motor Vehicle

(71) Applicant: Bayerische Motoren Werke Aktiengesellschaft, Muenchen (DE)

(72) Inventors: Matthias FINK, Muenchen (DE); Marco HIPPLER, Muenchen (DE)

(21) Appl. No.: 19/428,428

(22) Filed: Dec. 22, 2025

(30) Foreign Application Priority Data
Jan. 22, 2025 (DE) 10 2025 102 313.1

(51) Int. Cl. H04L 9/08; B60R 25/24

(52) U.S. Cl. CPC H04L 9/0866; B60R 25/24

(57) ABSTRACT

A method for generating a digital access key for a motor vehicle includes receiving identification information for a digital access key for a motor vehicle from a first remote computing unit at a user terminal. The identification information includes a reference to an Internet resource. The Internet resource includes motor vehicle identification information for the motor vehicle. The Internet resource is called and the motor vehicle identification information is provided from the user terminal at a second remote computing unit. Generation information for a digital access key for the motor vehicle is generated based on the motor vehicle identification information. A digital access key for the motor vehicle is generated based on the generation information.

### CROSS REFERENCE TO RELATED APPLICATION

This application claims priority under 35 U.S.C. § 119 from German Patent Application No. DE 10 2025 102 313.1, filed Jan. 22, 2025, the entire disclosure of which is herein expressly incorporated by reference.

### BACKGROUND AND SUMMARY

The invention relates to a method and a device for generating a digital access key for a motor vehicle.

Solutions exist for enabling access and in particular unlocking of a motor vehicle with the aid of a so-called smart device. This typically takes place after a digital access key has been configured on the smart device.

For example, a method for operating an authorization device for a vehicle is specified in document DE 10 2015 223 342 A1, which is designed for a first communication with the vehicle and has a locating unit which is designed to ascertain a current location of the authorization device.

The object of the invention is to provide an improved method and an improved device.

This object is achieved by various aspects of the one or more embodiments described herein.

A method according to the invention for generating a digital access key for a motor vehicle comprises in this case the steps of receiving identification information for a digital access key for a motor vehicle from a first remote computing unit at a user terminal, wherein the identification information comprises a reference to an Internet resource, wherein the reference to the Internet resource comprises motor vehicle identification information for the motor vehicle, calling the Internet resource comprising providing the motor vehicle identification information from the user terminal at a second remote computing unit, generating generation information for a digital access key for the motor vehicle based on the motor vehicle identification information, and generating a digital access key for the motor vehicle based on the generation information.

The method according to the invention is used in particular to identify a motor vehicle with the aid of vehicle identification information as early as possible in a generation process for a digital access key and to provide this information at a user terminal in order to then be able to use it deliberately in the further generation process, both at the user terminal and also at other devices and in particular for further user terminals. The term information is used synonymously hereinafter both in the singular and in the plural and can also only comprise a single item of information.

A user terminal, which can also be referred to as a user device, is a device or an apparatus here which is designed to receive operating inputs, user inputs, and/or user commands and to communicate with a motor vehicle, in particular to provide these operating inputs at the motor vehicle and thus trigger functions at the motor vehicle.

In particular, the user terminal is a portable or mobile device different from the motor vehicle, which can be designed in particular as a so-called smart device, thus as a device having at least one processor unit, such as a smart phone, a phablet or a tablet, a smartwatch, smart glasses, and/or a wearable, which also provides other functions, such as telephoning, surfing the Internet, or messaging services, for example, by way of apps or programs. In particular, the user terminal is also designed to receive, process, and/or call a reference to an Internet resource and/or a remote computing unit, as will also be explained in the further course of things.

In particular, the user terminal is designed to trigger or carry out one or more functions with respect to one or more motor vehicles, such as locking and/or unlocking one or more hatches, for example, doors and in particular also actively opening and/or closing one or more such hatches, and also disengaging an immobilizer, starting a motor, and/or moving the motor vehicle forward.

Such functions or interactions with the motor vehicle, in particular those which enable an access or a hatch control and/or a movement of the motor vehicle, can also be referred to as secure and/or secured functions and are in particular assisted by a secure module in or from the user terminal or are implemented therein. Such a secure module can in this case contain both hardware components, for example, in the form of a secure processor and/or a secure storage area, and software components, for example, one or more apps, applications, or programs, which interact.

For this purpose, the user terminal requires a digital access key, which at the time of the beginning of the method is not yet available, in any case not yet available on the user terminal, in particular because this has not and/or not yet been generated. The method according to the invention is directed to this generation of an in particular first digital access key for the motor vehicle. Such a digital access key can be based in particular on an asymmetric cryptographic system and/or such a use, wherein both the motor vehicle and the user terminal have a private key and a public key which are designed to authorize or legitimize one another. Further information can also be incorporated into the digital access key, as will also be explained in the further course of things.

In particular, an original or first digital access key for the motor vehicle is generated in the course of this method. This process can also be referred to as owner coupling or owner pairing. The user terminal, which can also be referred to as an owner device, is in particular assigned tiered to the same user or owner as the motor vehicle.

For this purpose, identification information for a digital access key for a motor vehicle from a first remote computing unit is received at a user terminal.

The first remote computing unit, which can also be referred to as the first computing unit and in particular as the motor vehicle management device, is different here from the motor vehicle and the user terminal and is formed separately and spaced apart. The first remote computing unit can in this case comprise one or more servers, which are also partially or completely organized in the cloud. The first remote computing unit can in particular be operated by a producer and/or service provider of the motor vehicle and can be used, in particular exclusively, for generating and/or managing one or more digital access keys for one or more motor vehicles.

The communication between the user terminal and the first remote computing unit can in particular take place here via one or more wireless communication protocols or standards, in particular far field communication protocols, such as one or more of WLAN or WIFI and/or mobile wireless, in particular 3G, 4G, 5G, etc. In particular, the identification information is received via email, SMS, message, and/or push message, for example, in an app.

The reception of the identification information can in particular be the first step of the method here and in particular can trigger the method. Alternatively, the reception of the identification information can be preceded by a generation request, which triggers the method. This generation request can be triggered, for example, by a or the user and/or a customer service representative or service employee, in order to generate a, in particular the, first digital access key.

This generation request can be provided here by the first user terminal or by another device, which is in particular authorized for this purpose, at the first remote computing unit, for example, with more extensive information, which in particular identifies the user and/or the user terminal, such as a mobile wireless number, a username, and/or an email address, and the identification information is provided in response thereto.

The identification information comprises here a reference to an Internet resource, wherein the reference to the Internet resource comprises motor vehicle identification information for the motor vehicle.

The motor vehicle identification information, which can also be referred to as motor vehicle information, comprises one or more items of information here which enable the motor vehicle to be unambiguously identified. This can comprise, for example, a vehicle identification number (VIN) or can be derived therefrom. Alternatively, the motor vehicle identification information can also not comprise a reference to a VIN, but rather can be information managed or stored only for this purpose. The motor vehicle identification information is in particular saved here at the first remote computing unit or stored therein.

This motor vehicle identification information is incorporated here into a reference to an Internet resource or integrated therein. This can take place either in clear text or in encrypted form or not in clear text, for example, as a hash. In particular, the motor vehicle identification information is incorporated as an argument in the reference or added thereto. The reference, which can also be referred to as a link or uniform resource locator (URL), can comprise, for example, between 4 and 16 characters, in particular 8, furthermore in particular precisely 8 characters. The reference can also contain further information, at least the reference to the Internet resource itself, such as an Internet or web address and/or a domain. The reference can also comprise further information, such as a version, a query, a reference to a technology or scheme used, in particular in the key generation, and/or further information, such as control parameters for the call of the Internet resource in particular. In particular, the reference also comprises checking information, as will be explained in the further course of things.

In particular, the reference to an Internet resource in the form of a URL can be assembled as described in the following table, wherein the reference can be assembled in particular in the sequence described from top to bottom in the table (from left to right) (optional components can be omitted:

| Component | Character length | Description | mandatory? |
|---|---|---|---|
| Scheme | 5 | https, http protocol via | mandatory |
| | | TLS | |
| Authority | 21 | Domain name, which | mandatory |
| | | is defined by an in | |
| | | particular second | |
| | | remote computing unit | |
| | | and refers thereto, for | |
| | | example, | |
| | | digitalkeypairing.org | |
| Version | 2 | Version number, | mandatory |
| | | which identifies the | |
| | | individual fields in the | |
| | | reference, for | |
| | | example, v1 | |
| Forwarding | 4 | Motor vehicle | mandatory |
| | | producer identification | |
| | | information, use used | |
| | | for forwarding to a | |
| | | remote computing | |
| | | unit. | |
| Query | | Nonsensitive URL | mandatory |
| | | parameters | |
| Technology | Variable | Communication | optional |
| | | interface technologies | |
| | | which are supported | |
| | | for key generation, | |
| | | such as NFC or NFC, | |
| | | BLE. If this | |
| | | component is not | |
| | | defined, NFC is | |
| | | assumed | |
| Graphic | 12 | Graphic position | optional |
| | | identification | |
| | | information, which | |
| | | defines a position of a | |
| | | graphic of a producer | |
| | | of the motor vehicle at | |
| | | a communication | |
| | | device, such as an | |
| | | NFC read device. This | |
| | | component is | |
| | | reproduced as a string | |
| | | and is assembled from | |
| | | the above-mentioned | |
| | | motor vehicle | |
| | | producer identification | |
| | | information and motor | |
| | | vehicle graphic | |
| | | identification | |
| | | information, wherein | |
| | | this motor vehicle | |
| | | graphic identification | |
| | | information comprises | |
| | | 4 bytes. | |
| Fragment | | Sensitive URL | mandatory |
| | | parameters, the user | |
| | | terminal extracts this | |
| | | fragment from the | |
| | | URL if the URL is | |
| | | used to contact an in | |
| | | particular second | |
| | | computing unit and | |
| | | ensures the | |
| | | confidentiality. | |
| Password | 8 | Password for key | mandatory |
| | | generation | |
| Vehicle ID | 8 | Motor vehicle | mandatory |
| | | identification | |
| | | information | |
| Checksum | | Check information | mandatory |

In a further step, this previously received Internet resource is called by the user terminal, wherein the motor vehicle identification information contained in the Internet resource is provided by the user terminal at a second remote computing unit by the call. In particular, the Internet resource or the reference refers to the second remote computing unit.

The second remote computing unit, which can also be referred to as a second computing unit and in particular as a user terminal management unit, is different here from the motor vehicle and the user terminal, formed separately and spaced apart, and in particular is constructed essentially like the first remote computing unit. In particular, the first computing unit and the second computing unit can also be the same computing unit. Alternatively, the second computing unit is different from the first computing unit and/or is constructed separately. The second remote computing unit can in particular be operated by a producer and/or service provider of the user terminal and can be used, in particular exclusively, for generating and/or managing one or more digital access keys for one or more user terminals.

Generation information for a digital access key for the motor vehicle is then created based on the motor vehicle identification information. The generation information is information and/or data here which are required to generate such a digital access key for the motor vehicle. However, in particular this generation information is not exhaustive and further generation information can exist and/or can be generated, derived, and/or acquired in the further course of the method, which is necessary for the final generation of the one, in particular first, and/or further digital access keys.

In particular, this generation information is certificate information, in particular a so-called instance CA certificate, which can also be referred to as an output certificate and using which one or more, in particular further digital access keys can be signed in the further course of the method. In other words, the motor vehicle identification information is incorporated in such a certificate or embedded therein so that it is comprised thereby.

This generation information can be generated and/or stored here both at the user terminal and also at the second remote computing unit. In particular, the generation information is generated at the second remote computing unit based on the motor vehicle identification information previously provided by the user terminal and stored there and also provided at the user terminal.

A digital access key for the motor vehicle is then generated based on the generation information. In particular, a first digital access key for the motor vehicle is created based on the generation information, which comprises the motor vehicle identification information, for the user terminal. This takes place in particular at the user terminal using the previously provided generation information and in particular the output certificate.

Functions of the motor vehicle, such as locking and/or unlocking of the motor vehicle, as described above can then be triggered using the generated digital access key with the aid of the user terminal.

The method according to the invention enables a motor vehicle to be identified with the aid of motor vehicle identification information as early as possible in a generation process for a digital access key and this information to be provided at a user terminal in order to be able to use it deliberately in the further generation process.

According to one refinement, the identification information furthermore comprises checking information, wherein the method furthermore comprises the step of checking the identification information based on the checking information.

Checking information is information in this case which enables a third party to check whether the identification information and in particular also the reference to the Internet resource are correct and genuine or whether they are false, forged, and/or have been modified. This checking information is then added to the reference to the Internet resource, in particular as a further argument.

Such checking information is typically derived from one or more items of the identification information itself, as will also be explained in the further course of things. In particular, the checking information is a checksum, in particular one which can be generated from a cyclic redundancy check (CRC) and/or can be created and/or checked with the aid of such a checking method. In particular, it is a method according to the standard CRC-8, CRC-16, or CRC-32. The checking information is then in this case, for example, a polynomial having 8, 16, or 32 bits.

This refinement enables it to be checked whether the identification information and in particular the reference to the Internet resource are correct and genuine or whether they are false, forged, and/or have been changed. This refinement is particularly secure.

According to one refinement, the step of calling the Internet resource only takes place if the check was successful.

The Internet resource is those only or exclusively called when the checking information and in particular the checksum have been checked and found to be correct. In contrast, if they have not found to be correct, thus the checking has failed, the Internet resource is then not called.

Alternatively or additionally, the provision of the motor vehicle identification information from the user terminal at the second remote computing unit only takes place when the check was successful and/or the checksum was checked and found to be correct and otherwise not.

This refinement enables a false and/or forged reference not to be opened and in particular the vehicle identification information not to be provided at a false location. This refinement is particularly secure.

According to one refinement, the checking information is based on the motor vehicle identification information.

The checking information is formed here at least based on the motor vehicle identification information or derived therefrom. In particular, the checksum is generated taking into consideration or using the motor vehicle identification information. In particular, the checking information is formed based on the complete reference to the Internet resource or derived therefrom and subsequently this checking information is added to the Internet resource.

This refinement enables it to be checked particularly accurately and simultaneously with little additional effort whether the identification information or the reference is correct.

According to one refinement, the generation of generation information comprises forming a hash value based on the motor vehicle identification information.

According to this refinement, a hash value is formed using the motor vehicle identification information.

Further information can also be incorporated into the formation of the hash value, in particular identification information of the user terminal, the user, or a user account assigned thereto, and/or a so-called salt, thus a random character sequence. In particular, a secure hash algorithm (SHA) is used, in particular a SHA256.

This hash value can then in particular be added to the generation information and/or the generation information can be generated based on the hash value. In particular, this hash value is added to the output certificate. This hash value can also be referred to as account information hash. The house value is in particular generated at the second remote computing unit and/or added to the output certificate.

This refinement enables a digital access key to be generated particularly securely.

According to one refinement, the generation of the digital access key is carried out based on the hash value.

The digital access key is therefore created using the previously generated hash value. In particular, a generated digital access key can be checked with the aid of the hash value.

This refinement enables a digital access key to be generated particularly securely.

According to one refinement, the generation of the digital access key is carried out for a user terminal different from the user terminal.

In particular, two digital access keys are generated in the present case. Initially, a first original one for the first user terminal, as described above. At a later time, a second further digital access key is generated, in the present case for a second user terminal, which is different from the first above-described user terminal, but can in particular be constructed or designed identically or similarly as described above with reference to the first user terminal. The second user terminal can be assigned here to the user of the first user terminal or a further second user.

In particular, second identification information for the second digital access key can be provided by the first user terminal at the second user terminal, wherein the second identification information comprises the vehicle identification information and likewise a reference to an Internet resource for the second computing unit. When this reference is then called and the vehicle identification information is provided by the second user terminal at the second remote computing unit, there, at the second remote computing unit, the correctness of the reference or the query can be checked with the aid of the vehicle identification information stored there.

This refinement enables a digital access key for a second user terminal to be generated particularly securely.

According to a further aspect, a device for generating a digital access key for a motor vehicle is specified.

The device comprises means here which are designed to carry out a method according to any one of the above-described embodiments. In particular, the device comprises one or more processor units in order to carry out the above-described method. The device also comprises in particular a memory, on which code is stored, in particular in a nonvolatile manner, which, when it is executed by a processor unit, causes it to carry out the above-described method.

In particular, the device can comprise at least the user terminal, one or more remote computing units, in particular the first and/or second remote computing unit, and/or the motor vehicle, can form a system therewith, and/or can interact therewith in order to carry out the above-described method.

Reference is made to the above-explained advantages and refinements of the method with respect to the advantages of the device and its refinements and their advantages.

Further features of the invention result from the claims, the FIGURES, and the description of the figures. The features and combinations of features mentioned above in the description and the features and accommodations of features mentioned hereinafter in the description of the figures and/or solely shown in the figures are usable not only in the respective specified combination, but also in other combinations or alone.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic perspective view of an embodiment of a method and a device for generating a digital access key for a motor vehicle.

### DETAILED DESCRIPTION OF THE DRAWINGS

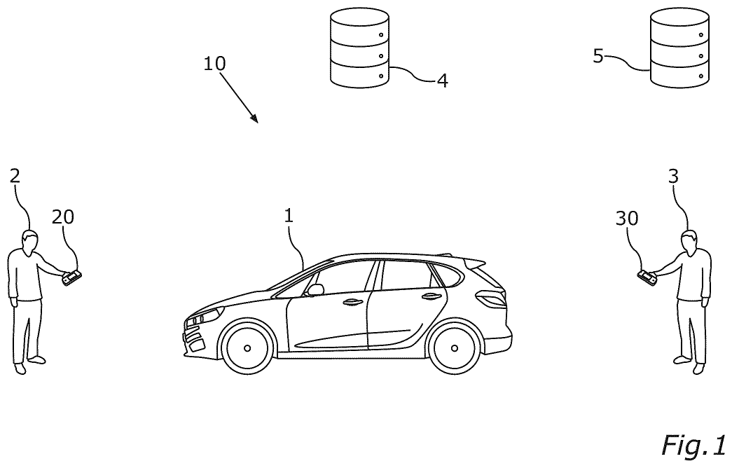

FIG. 1 shows a schematic perspective view of an embodiment of a method and a device 10 for generating a digital access key for a motor vehicle 1

The device 10 comprises a first user terminal 20 of a first user 2 and optionally a first computing unit 4 and/or a second computing unit 5 and/or a second user terminal 30 of a second user 3 or has a communication connection thereto. The device 10 is designed to carry out or at least to effectuate the steps of the method described in the further course of things.

The device 10 is primarily designed to receive identification information for a digital access key for the motor vehicle 1 from the first remote computing unit 4 at the user terminal 20.

The identification information comprises here a reference to an Internet resource, wherein the reference to the Internet resource comprises motor vehicle identification information for the motor vehicle 1.

The identification information also comprises checking information which is based on the motor vehicle identification information.

The device 10 is also designed to check the identification information and in particular the reference based on the checking information.

The device 10 is also designed to called the Internet resource and in this case to provide the motor vehicle identification information from the user terminal 20 at a second remote computing unit 5, in particular exclusively if the check was successful.

The device 10 is also designed to generate generation information for a digital access key for the motor vehicle 1 based on the motor vehicle identification information. The generation of the generation information also comprises a formation of a hash value based on the motor vehicle identification information here.

The device 10 is also designed to generate a digital access key for the motor vehicle 1 based on the generation information.

The digital access key can be generated here for the first user terminal 20 and/or for the second user terminal 30.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 motor vehicle
2 first user
3 second user
4 first remote computing unit
5 second remote computing unit
10 device
20 first user terminal
30 second user terminal

What is claimed is:

1. A method for generating a digital access key for a motor vehicle, comprising:
receiving identification information for a digital access key for a motor vehicle from a first remote computing unit at a user terminal, wherein the identification information comprises a reference to an Internet resource, wherein the reference to the Internet resource comprises motor vehicle identification information for the motor vehicle;
calling the Internet resource, wherein calling the Internet resource includes providing the motor vehicle identification information from the user terminal at a second remote computing unit;
generating generation information for a digital access key for the motor vehicle based on the motor vehicle identification information; and
generating a digital access key for the motor vehicle based on the generation information.

2. The method of claim 1, wherein the identification information includes checking information, the method further comprising:
checking the identification information based on the checking information.

3. The method of claim 2, wherein the step of calling only takes place if the checking was successful.

4. The method of claim 2, wherein the checking information is based on the motor vehicle identification information.

5. The method of claim 1, wherein the generation of generation information comprises forming a hash value based on the motor vehicle identification information.

6. The method of claim 5, wherein the generation of the digital access key takes place based on the hash value.

7. The method of claim 1, wherein the generation of the digital access key takes place for a user terminal different from the user terminal.

8. A device for generating a digital access key for a motor vehicle, wherein the device is configured to carry out the method of claim 1.
